(19) United States
(12) Patent Application Publication
(10) Pub. No.: US 2018/0238535 A1
(43) Pub. Date: Aug. 23, 2018

(54) Film-Like Lighting Device

(71) Applicant: LUPYLED GmbH, Forchtenberg (DE)

(72) Inventors: Alexander Goerz, Forchtenberg (DE); Dominik Rabus, Forchtenberg (DE)

(21) Appl. No.: 15/757,338

(22) PCT Filed: Sep. 5, 2016
(86) PCT No.: PCT/EP2016/070801

§ 371 Date: Mar. 2, 2018

(30) Foreign Application Priority Data
Sep. 4, 2015 (DE) 10 2015 114 842.0

(51) Int. Cl. F21V 33/00; F21S 8/00; F21V 23/04; F21S 10/00

(52) U.S. Cl. CPC F21V 33/006; F21S 8/032; F21Y 2105/10; F21V 23/0442; F21S 10/002; F21S 8/033

(57) ABSTRACT

A Film-Like Lighting Device (1) for mounting on walls (14), ceilings (12), floors (15) and the like has at least one film element (2) and a plurality of light-emitting diodes (3) integrated into the film element (2) and/or laser beam-generating devices which are operatively connected to a control unit (4) and can be controlled individually or in groups by means of the control unit (4).

The invention relates to a Film-Like Lighting Device for attaching to walls, ceilings, floors and the like. In addition, the invention relates to a method for manufacturing a Film-Like Lighting Device and a method for controlling same.

DE 10 2004 026 730 A1 describes a lighting device in which a surface is provided with luminous means in the form of light-emitting diodes (LEDs). Optical effects can be achieved by the luminous means, for example, in the form of individual light spots from light spots arranged in the form of letters and/or patterns to surface emission of light over the entire surface area.

DE 10 2011 079 741 A1 describes a light having a plurality of light-emitting diodes and a control unit for individual control of the light-emitting diodes. The light-emitting diodes are arranged on the surface of a sphere.

DE 10 2008 013 589 A1 describes a lighting device for an aquarium, in which blue and white light-emitting diodes arranged in a grid on a carrier are used.

Control of light-emitting diodes for an aquarium by means of an electronically triggered operating device is known from DE 20 2006 001 686 U1.

DE 10 2004 047 766 C5 describes a lighting device having at least two light-emitting diode modules and a control unit, by means of which the color temperature of the light generated by the light-emitting diodes can be adjusted.

DE 601 28 140 T2 describes a lighting device for generating a lighting pattern having a variable shape and luminous intensity. The lighting device here is at least partially transparent.

The object of the present invention is to create a novel lighting device which can be used in particular in buildings and with which completely novel effects can be achieved.

This object is achieved according to the invention by the features defined in claim 1.

The inventive lighting device can be applied with no problem to walls, ceilings, floors and other areas of a building structure and can also be used as sails, room dividers or the like. In both of the latter cases, the Film-Like Lighting Device may be at a distance from the respective building structure, but it is also possible to apply them directly to the wall, ceiling or floor so that approximately no additional space is required.

Due to the use of the at least one film element, this results in a very flexible lighting device which can be adapted to a wide variety of sizes and shapes of the respective building structure. Due to the light-emitting diodes and/or laser beam-generating devices integrated into the film element, a compact lighting device that is very easy to handle and install is created and can also be integrated into existing building structures.

Due to the inventive controllability of the light-emitting diodes and/or laser beam-generating devices by means of the control unit, a wide variety of lighting effects can be achieved so that the result is completely novel lighting possibilities for the respective space. This yields a very high flexibility for the user with regard to the control of the lighting device.

According to the invention, the light-emitting diodes and/or laser beam-generating devices can also be triggered individually by means of the control unit or in groups, which is a major difference in comparison with the known approaches. In particular it is possible to trigger in principle any number of light-emitting diodes and/or laser beam-generating devices, namely with regard to the intensity of the radiation emitted by same as well as with regard to the time during which they are activated.

To be able to achieve controllability of the light-emitting diodes and/or laser beam-generating devices by means of the control unit as a function of various factors, in a very advantageous refinement of the invention it is possible to provide that at least one sensor for detecting brightness and/or at least one sensor for detecting motion and/or at least one sensor for detecting temperature and/or at least one sensor for detecting emotions of a person and/or at least one infrared sensor is integrated into the at least one film element. Various numbers and in principle any number of the respective sensors may be integrated into the at least one film element to be able to achieve the desired control of the light-emitting diodes and/or laser beam-generating devices.

In addition, it is possible to provide that at least one interface with a building network is integrated into the at least one film element in order to assure a power supply for the light-emitting diodes and/or laser beam-generating devices and the control unit on the one hand and on the other hand be able to perform control of the light-emitting diodes and/or laser beam-generating devices on the basis of additional factors.

In another advantageous embodiment of the invention, if there is a plurality of individual film elements, which are electrically and/or physically connected to one another, then it is also possible to cover larger areas with the Film-Like Lighting Device according to the invention. In the case of an electrical connection of the individual film elements in particular, control of all the light-emitting diodes and/or laser beam-generating devices of the Film-Like Lighting Device is possible so that the entire lighting device can be controlled as a whole. However even in a case in which each film element is controlled wirelessly, all film elements are controlled as a whole so that their need no necessarily be an electrical connection between the individual film elements.

A particularly simple embodiment structurally of the inventive lighting device is obtained when the film element has a conducting film with light-emitting diodes and/or laser beam-generating devices also integrated into same and a cover film that is transparent on one side placed on the visible side of the at least one film element.

Additional lighting effects can be achieved here if the cover film is equipped with devices for varying the emission characteristic of the light-emitting diodes and/or laser beam-generating devices. The emission characteristic of the light-emitting diodes and/or laser beam-generating devices may in turn be implemented individually or in groups. It is posse here to adjust several groups and/or several individual devices independently of one another for modifying the emission characteristic.

A particularly advantageous embodiment of the invention may consist of the fact that the at least one film element with the light-emitting diodes and/or laser beam-generating devices is manufactured by a generative method. The Film-Like Lighting Device according to the invention can be manufactured in a particularly economical manner by using a generative method, for example, an additive fabrication method such as 3D printing, the melt strand deposition method or selective laser sintering.

A method for manufacturing a Film-Like Lighting Device is defined in claim 8.

By means of such a generative method, the at least one film element together with the light-emitting diodes and/or laser beam-generating devices can be manufactured in a particularly economical and therefore relatively inexpensive manner. An additive fabrication method, such as 3D printing, the melt strand deposition method or selective laser sintering may be considered in particular.

Claim 9 defines a method for controlling a Film-Like Lighting Device.

Completely novel effects which are advantageous for a user in that the location where he is at the moment is always illuminated can be achieved with such a method. Furthermore, this makes it possible to achieve energy savings because areas unoccupied by a person are not illuminated accordingly. Such a control of the Film-Like Lighting Device may of course also be combined with other types of control.

Another method for controlling the Film-Like Lighting Device is obtained from claim 10.

A very simple means of operating the inventive lighting device can be achieved by gesture control.

Embodiments of the invention are illustrated in principle on the basis of the following drawings.

In these drawings:

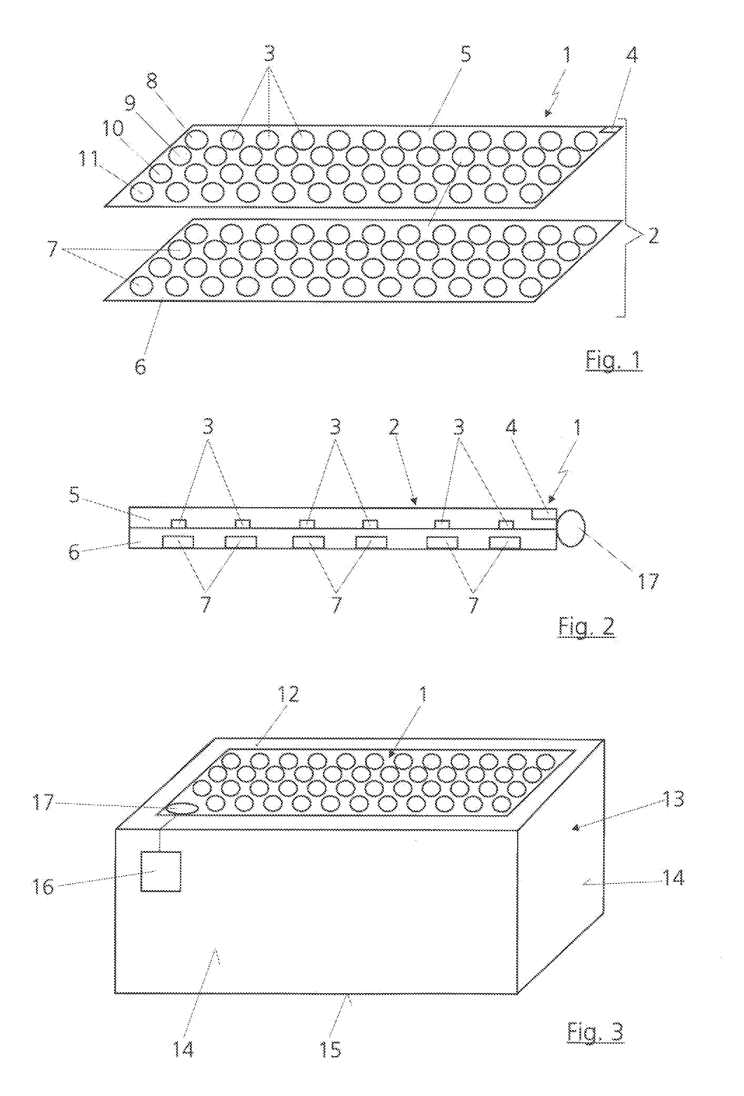

FIG. 1 shows a highly schematic exploded perspective diagram of a Film-Like Lighting Device according to the invention;

FIG. 2 shows a highly schematic side view of the lighting device from FIG. 1 and

FIG. 3 shows an example of an arrangement of the lighting device from FIG. 1 and FIG. 2 on the ceiling of a room.

FIGS. 1 and 2 show a Film-Like Lighting Device 1 having a film element 2 and a plurality of light-emitting diodes 3 integrated into the film element 2 Instead of or in addition to the light-emitting diodes 3, laser beam-generating devices may also be provided. The following description refers for the sake of simplicity only two light-emitting diodes wherein all of the features described below can also be used with laser beam-generating devices.

The light-emitting diodes 3 are operatively connected to a control unit 4, which is indicated only schematically and can be controlled individually or in groups by means of the control unit 4. When the light-emitting diodes 3 are controlled “in groups” this refers to simultaneous control of a plurality of light-emitting diodes, which are preferably arranged adjacent to one another, but that is not absolutely necessary. Groups of light-emitting diodes 3 and individual light-emitting diodes 3 can thus be controlled in any desired manner, independently of one another, with regard to their brightness and/or intensity and with regard to their dynamics, i.e., the chronological course of their activation and deactivation time.

The type and manner of the connection of the light-emitting diodes 3 to the control unit 4 is not discernible in the figures. It may be embodied as cabling or as a wireless connection. Some or all of the light-emitting diodes 3 can be connected to one another by means of a bus system. Such a bus system which may be of any known design, can also establish the connection of the light-emitting diodes 3 to the control unit 4. Instead of a bus system, a network system is also conceivable. The control unit 4 for controlling the light-emitting diodes 3 may be of an essentially known design and will therefore not be described in greater detail below. If necessary, more than one control unit 4 may also be used. In addition, other control options for the light-emitting diodes 3 are also conceivable.

As additionally indicated in FIG. 1, the film element 2 has a conducting film 5 into which the light-emitting diodes 3 are integrated, as well as a cover film 6 which is preferably transparent on one side. The light-emitting diodes 3 and their cabling as well as the control unit 4 are thus not discernible through the cover film 6. Alternatively, use of a cover film 6 that is transparent on both sides would also be conceivable. The cover film 6 in the present case is equipped with devices 7 for altering the emission characteristic of the light-emitting diodes 3. The devices 7 may be lenses embodied in a suitable form or the like. Alternatively, or in addition to lenses, prisms or mirrors may also be used as the devices 7 for altering the emission characteristic of the light-emitting diodes 3. The lenses and/or prisms can be rolled after they are manufactured in order to induce targeted deformations in same. Recesses can also be created in the cover film 6 by rolling and then the conductor strips for connecting the light-emitting diodes can be accommodated in these recesses. FIG. 1 shows the conducting film 5 and the cover film 6 at a distance from one another to facilitate the illustration, but the actual mutual arrangement of the conducting film 5 and the cover film 6 corresponds more to the diagram according to FIG. 2. It is fundamentally possible here to assign the devices 7 to individual light-emitting diodes 3 and/or groups of a plurality of light-emitting diodes 3 so that the emission characteristic of individual light-emitting diodes 3 and/or one or more groups of light-emitting diodes 3 can be altered and/or influenced.

For example, the light-emitting diodes 3 can be cooled passively by means of an endothermic reaction in which the heat of the light-emitting diodes 3 is used in a chemical reaction to achieve a different chemical condition.

The at least one film element 2 with the light-emitting diodes 3 is preferably manufactured by a generative method in particular an additive fabrication method, for example, 3D printing, melt strand deposition or selective laser sintering. In the case of the embodiment illustrated with the conducting film 5 and the cover film 6, both the conducting film 5 with the light-emitting diodes 3 and the cabling integrated therein as well as the cover film 6, which is transparent on one side, can be produced by the generative method. The devices 7 for altering the emission characteristic of the light-emitting diodes 3, i.e., for example, the lenses and/or prisms can also be created by means of the generative method. In this case the use of organic light-emitting diodes 3, so-called OLEDs, is preferred. Such OLEDs can be manufactured relatively easily by means of a generative method, for example, by means of 3D printing. When using laser beam-generating devices, they can optionally also bed manufactured by means of the generative method but it is also possible to integrate them as additional components into the film element 2. In the case of using laser beam-generating devices, it is possible to implement them as organic laser devices (OLDs). These organic lasers can be manufactured by means of generative methods in an essentially known way.

in the case of a Film-Like Lighting Device 1 which covers a very large area, a plurality of individual film elements 2 which are electrically and/or physically connected to one another may be provided in a manner not shown here. The corresponding connecting elements for electrical and/or physical connection of the film elements 2 are preferably integrated into these elements, and in the case of production of the film elements 2, can also be manufactured by the generative method. In doing so, the film element 2 may be available by the yard, so that approximately any sizes and shapes of the Film-Like Lighting Device 1 can created with very little effort.

In addition, a plurality of sensors 8, 9, 10 and 11 the function of which will be described at a later point in time are integrated into the film element 2. The sensors 8, 9, 10 and 11, the number of which can be regarded as unlimited, are also connected to the control unit 4 in a manner not illustrated here and can also be manufactured by the generative method.

FIG. 3 shows an example of an arrangement of the Film-Like Lighting Device 1 on a ceiling 12 of a room 13. Instead of the ceiling 12, the lighting device 1 may also be mounted on a wall 14 and/or on a floor 15 of the room 13. The lighting device 1 may be arranged on the wall 14 in the manner of a wall hanging In addition, it would be possible to use the Film-Like Lighting Device 1 in the form of a sail, for example, an awning or a solar sail or ship sail, a room divider, a screen or the like. It is also conceivable to hold the lighting device 1 so that it is mounted in the room 13, for example, by means of strong magnets, in particular electromagnets as well as wireless energy transmission. Use of the Film-Like Lighting Device 1 is also conceivable, for example, in motor vehicles or in wet areas, for example, in swimming pools or saunas, because the Film-Like Lighting Device 1 can also be embodied in a waterproof version.

The lighting device 1 described herein may be mounted in any manner and in any location. Multiple lighting devices 1 can be combined by means of a suitable interface (not shown) to form a joint controllable lighting device 1. Such a combination of a plurality of lighting devices 1 and control of same by means of the control unit 4 is also possible in various locations throughout the world, for example, when they are connected to one another over the Internet. The respective Film-Like Lighting Devices 1 may of course also be controlled by single control unit 4, for example, when the respective Film-Like Lighting Device 1 is provided in several rooms in a building.

FIG. 3 also shows in a highly schematic form a building network 16, which is connected to the Film-Like Lighting Device 1 by an integrated interface 17, which is integrated into the at least one film element 2 and is also indicated in a highly schematic manner. It is possible in this way to access the control unit 4 from the building network 16 and the light-emitting diodes 3 can be operated in a certain way. The power supply can also be provided from the building network 16 over the interface 17.

For example, it is possible to control the light-emitting diodes 3 in such a way that light emitted by the light-emitting diodes 3 follows a person (not shown) moving in relation to the Film-Like Lighting Device 1. In doing so, a cone of light illuminates the path traversed by the person. The person thus travels through the room 13 in a lighted path. To do so, one of the sensors, for example, sensor 8, is designed to detect motion. It is also possible to activate the Film-Like Lighting Device 1 as soon as a person is detected in the room 13.

Another possibility of controlling the Film-Like Lighting Device 1 consists of controlling it by gesture control. The sensor 8 embodied as a motion sensor may also be used for this purpose. For example, the brightness, color and orientation of the devices 7 for changing the emission characteristic of the light-emitting diodes 3 can be influenced by gesture control.

In the present case, the sensor 9 is also designed for detecting brightness and the sensor 10 for detecting temperature. Sensor 11 is an infrared sensor. Sensors 8, 9, 10 and 11 are used to detect the current status within the room 13 to he able to create the light configuration currently needed and/or requested from this information. In the case of use of the Film-Like Lighting Device 1 on the wall 14 or on the floor 15 in particular, one or more pressure sensors may also be provided, with which the Film-Like Lighting Device 1 can be controlled. Such a pressure sensor can be used, for example, in the manner of a switch or an operating unit.

In addition, a sensor (not shown) may also be provided for detecting a person's emotions but it need not necessarily be integrated into the film element 2. For example, the detection of emotions may be based on touching a door handle or door knob that can measure the conductivity of the skin or by a corresponding wrist hand, smart watch or ring. The sensor for detecting emotions is thus not assigned to the film element 2 in this case but instead is connected to the control unit 4 via the building network 16 and the interface 17. As an alternative or in addition to the measurement of emotions based on the conductivity of the skin, a user could also input his emotional situation directly via an input device such as a smart watch. The control unit 1 might convert this into a certain light configuration of the lighting device 1, as described above. It is possible to take into account the current time of day and to implement the light configuration accordingly.

It is fundamentally possible to interpret all the information together, obtained from the wide variety of sensors mentioned above, and optionally placed in a wide variety of positions, and to create a light scenario from the overall information thereby obtained.

Various types of data can of course be detected by means of several of the sensors described above, and this data can then be interpreted by the control unit 4, for example, to yield an overall scenario. A certain lighting effect or a or desired lighting effect or a combination of lighting and another effect, for example, music that is additionally imported can be implemented in this way, for example.

There is also the possibility of storing various user profiles in the control unit 4, so that a certain light distribution of the lighting device 1, for example, which is activated on entering the room 13, for example, is assigned to a certain user or a certain user group.

In addition, certain scenarios can be simulated with the lighting device 1, for example, a sunrise or a sunset or a starry sky. A representation of a certain weather situation, for example, the current weather, can also be implemented with the lighting device 1. A transparent ceiling 12 and/or wall 14, for example, can be simulated in the room 13, so that the result for the user appears to be close to nature in this way. A therapeutic light effect can be achieved in this way, making it possible to prevent seasonal affective disorder, for example. To this end, it is preferable to use light-emitting diodes 3 having certain wavelengths that produce the therapeutic light effect.

The lenses, prisms or mirrors forming the devices 7 described above for altering the emission characteristic of the light-emitting diodes 3 may have a focus (not shown), which the user can adjust. However, it is of course also possible to use nonadjustable lenses, prisms or mirrors. To control the lenses and/or prisms as well as to control additional functions of the Film-Like Lighting Device 1, the user can access an app that works with the control unit 4 via a smart phone, tablet or the like, for example.

The number and distribution of light-emitting diodes 3 illustrated here can be regarded as merely an example. Fundamentally any density of light-emitting diodes 3 can be provided, wherein, for example, 5000 light-emitting diodes 3 may be present on an area of 1 m². For example, it is possible in certain areas, for example, in the area of a dining room to provide a larger number of light-emitting diodes 3 and/or to control them differently. In this case a plurality of light-emitting diodes 3 can be controlled as a group.

The lighting device 1 can be adapted to the floor plan of the room 13, in particular when the plurality of individual film elements 2, which can be electrically or physically connected to one another, is provided as described above.

As indicated above, the cover film 6 is transparent on one side and opaque from the viewing side, i.e., from the side inside the room 13. From the standpoint of the user and/or in general the standpoint of a person in the room 13, the total visible surface of the lighting device 1 therefore acts like a white wall but of course other colors are also possible for the cover film 6. When the Film-Like Lighting Device 1 is turned off, it cannot be differentiated from a traditional ceiling, wall or floor surface. The cover film 6 may have approximately any external structure and can simulate, for example, a concrete surface, plasterwork, tile or the like.

A particularly preferred use of the Film-Like Lighting Device 1 consists of using it in an aquarium light because a wide variety of scenarios that are preferred for the respective types of creatures or plants in an aquarium can he established. Thus, for example, with the help of the devices 7 described above for changing the emission characteristic of the light-emitting diodes 3 and/or the laser beam-generating devices, certain areas that are advantageous for certain species of animal or plant can be created inside the aquarium. The control of such aquarium lights equipped with the Film-Like Lighting Device 1 can also be carried out from the same remote point, for example, over the Internet.

In addition, it is possible in one embodiment as aquarium lights to implement and use the aforementioned sensors for measuring the pH, the water hardness and similar parameters relevant in an aquarium. For example, there may be one or more sensors which determine one or more of the following parameters: carbonate hardness, total hardness, temperature, amount of nitrite, nitrate, ammonia, carbon dioxide, oxygen, phosphate, trace elements, calcium, magnesium, bicarbonate, aluminum, ammonium, antimony, arsenic, lead, boron, cadmium, chloride, chromium, cyanide, iron, fluoride, potassium, copper, manganese, sodium, mercury, selenium, silicate, strontium, sulfate, uranium, zinc, organic chlorine compounds, plant protectives and biocidal products as well as conductivity, microbial density of various microbes and redox potential. With such an aquarium light, the lighting can be controlled as a function of the water values, and in such a case it is also possible to adjust a disinfecting lighting, for example, if too many microbes are detected in the water.

1. A Film-Like Lighting Device (1) for mounting on walls (14), ceilings (12), floors (15) and the like, having at least one film element (2) and having a plurality of light-emitting diodes (3) integrated into the film element (2) and/or laser beam-generating devices that are operatively connected to a control unit (4) and can be controlled individually or in groups by means of the control unit (4).

2. The Film-Like Lighting Device according to claim 1, characterized in that at least one sensor (8) for detecting brightness and/or at least one sensor (8) for detecting motion and/or at least one sensor (10) for detecting temperature and/or at least one sensor for detecting a person's emotions and/or at least one infrared sensor (11) is/are integrated into the at least one film element (2).

3. The Film-Like Lighting Device according to claim 1 or 2, characterized in that at least one interface (17) to a building network (16) is integrated into the at least one film element (2).

4. The Film-Like Lighting Device according to claim 1, 2 or 3, characterized in that a plurality of individual film elements (2) is provided, connected electrically and/or physically to one another.

5. The Film-Like Lighting Device according to any one of claims 1 to 4, characterized in that the film element (2) comprises a conducive film (5) having light-emitting diodes (3) and/or laser beam-generating devices integrated into the conducting film, and having a cover film (6) that is transparent on one side, on the visible side of the at least one film element (2).

6. The Film-Like Lighting Device according to claim 5, characterized in that the cover film (6) is furnished with devices (7) for altering the emission characteristic of the light-emitting diodes (3) and/or laser beam-generating devices.

7. The Film-Like Lighting Device according to any one of claims 1 to 6, characterized in that at least one film element (2) with the light-emitting diodes (3) and/or laser beam-generating devices is manufactured by a generative method.

8. A method for manufacturing of Film-Like Lighting Device according to claim 7, wherein the at least film element (2) with the light-emitting diodes (3) and/or laser beam-generating devices is manufactured by a generative method.

9. The method for controlling a Film-Like Lighting Device according to any one of claims 1 to 7, wherein the light-emitting diodes (3) are controlled in such a way that light emitted by the light-emitting diodes (3) and/or the laser beam-generating devices follows a person moving in relation to the Film-Like Lighting Device (1).

10. The method for controlling a Film-Like Lighting Device according to any one of claims 1 to 7, wherein the light-emitting diodes (3) and/or the laser beam-generating devices are controlled by gesture control.
